(19) United States
(12) Patent Application Publication
(10) Pub. No.: US 2009/0192801 A1
(43) Pub. Date: Jul. 30, 2009

(54) SYSTEM AND METHOD FOR CONTROLLING AN ELECTRONIC DEVICE WITH VOICE COMMANDS USING A MOBILE PHONE

(75) Inventor: MENG-CHIEH CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/138,438

(22) Filed: Jun. 13, 2008

(30) Foreign Application Priority Data
Jan. 24, 2008 (CN) 200810300200.3

(51) Int. Cl. G10L 21/00

(52) U.S. Cl. 704/275; 704/E21.019

(57) ABSTRACT

A method for controlling an electronic device with voice commands using a mobile phone (1) includes: storing voice characteristics of voice command settings of a user and corresponding remote control signals of the voice command settings in a memory (12); recording voice command input of the user through a microphone (11) in the mobile phone; processing the voice command input, and detecting voice characteristics of the voice command input; determining whether the voice characteristics of the voice command input match voice characteristics of one of the plurality of voice command settings stored in the memory; and sending the remote control signal corresponding to the voice command setting that matches the voice command input to a wireless receiver (13) of the electronic device through a wireless transmitter (21) of the mobile phone, so as to control the electronic device remotely according the remote control signal.

### BACKGROUND OF THE INVENTION

1. Field of the Invention

The present invention generally relates to systems and methods for controlling an electronic device, and particularly to a system and method for controlling the electronic device with voice commands through a mobile phone.

2. Description of Related Art

In the last 30 years, television and other video technology have developed rapidly in going from analog to digital. Digital technology has many advantages over analog technology, the most significant being that digital data take up less bandwidth. This means that digital broadcasters/storage can provide more digital channels/data within the same bandwidth. Digital technology also provides superior picture quality and improve audio quality than analog technology.

Electronic devices, such as a video recorder, or a digital versatile disc player, utilize the digital technology. Generally, each of the electronic devices uses a remote controller for users to operate the electronic devices remotely and conveniently. However, in order to control the electronic devices comprehensively, remote controllers are becoming more and more complex. Users have to use remote controllers with complex functions and much time is spent on grasping the usage of the remote controllers. Thus the convenience of using remote controllers to control electronic devices becomes an inconvenience because of the complexity of the remote controller commands.

Accordingly, what is needed is a system and method for controlling an electronic device with a mobile phone using voice commands.

### SUMMARY

A method for controlling an electronic device with voice commands using a mobile phone is provided. The method includes: storing voice characteristics of voice command settings of a user and corresponding remote control signals of the voice command settings in a memory; recording voice command input of the user through a microphone in the mobile phone; processing the voice command input, and detecting voice characteristics of the voice command input; determining whether the voice characteristics of the voice command input match voice characteristics of one of the plurality of voice command settings stored in the memory; and sending the remote control signal corresponding to the voice command setting that matches the voice command input to a wireless receiver of the electronic device through a wireless transmitter of the mobile phone, so as to control the electronic device remotely according the remote control signal.

Other systems, methods, features, and advantages will be or become apparent to one skilled in the art upon examination of the following drawings and detailed description.

### BRIEF DESCRIPTION OF THE DRAWINGS

FIG. 1 is a functional block diagram of a system for controlling an electronic device with voice commands using a mobile phone in accordance with an exemplary embodiment.

FIG. 2 is a flowchart of preparations for controlling an electronic device with voice commands using a mobile phone in accordance with the exemplary embodiment.

FIG. 3 is a flowchart of a method for controlling an electronic device with voice commands using a mobile phone in accordance with the exemplary embodiment.

### DETAILED DESCRIPTION OF THE EMBODIMENTS

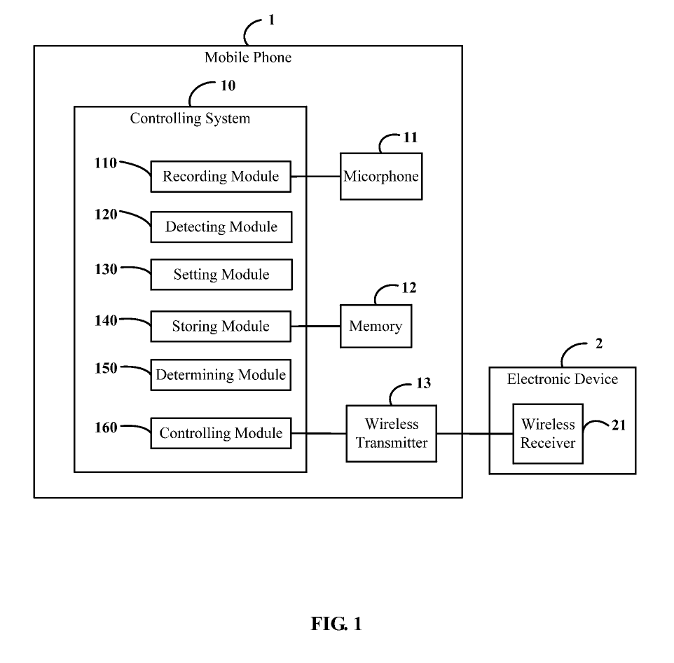

FIG. 1 is a functional block diagram of a system for controlling an electronic device with voice commands using a mobile phone (hereinafter “the voice controlling system”) in accordance with an exemplary embodiment. The controlling system 10 is installed in the mobile phone 1, and is configured for recording voice command inputs of a user and controlling the electronic device 2 that is connected to the mobile phone 1 wirelessly. The mobile phone 1 includes a microphone 11, a memory 12 and a wireless transmitter 13. The electronic device 2, which includes a wireless receiver 21, may be a video recorder, a television, an air conditioner, an electric fan, or a digital versatile disc player. In the exemplary embodiment, the wireless transmitter 13 and the wireless receiver 21 are infrared device. In other embodiment, the wireless transmitter 13 and the wireless receiver 21 may be Bluetooth devices or other kinds of devices, which can communicate with each other wirelessly.

The memory 12 may be an internal memory card or an external memory card. The external memory card typically includes a smart media card (SMC), a secure digital card (SDC), a compact flash card (CFC), a multi media card (MMC), a memory stick (MS), an extreme digital card (XDC), and a trans flash card (TFC). The memory 12 is configured for storing voice characteristics of a plurality of voice command settings and corresponding remote control signals.

The voice controlling system 10 includes a recording module 110, a detecting module 120, a setting module 130, a storing module 140, a determining module 150, and a controlling module 160.

The recording module 110 is connected to the microphone 11, and configured for recording a voice command setting of a user through the microphone 11.

The detecting module 120 is configured for processing the voice command setting and detecting voice characteristics of the voice command setting. The voice characteristics of the voice command setting may include, but not limited to a count of wave peaks, frequency bands of the wave peaks.

The setting module 130 is configured for setting a remote control function and a remote control signal corresponding to the voice command setting. The remote control function may include, but not limited to, a volume adjustment, a color settings, and a channel switching.

The storing module 140 is connected to the memory 12, and configured for storing the voice characteristics of the voice command setting and the remote control signal corresponding to the voice command setting in the memory 12.

The determining module 150 is configured for determining whether another remote control function needs to be set. If another remote control function needs to be set, the system repeatedly controls the recording module 110, the detecting module 120, the setting module 130, and the storing module 140 as described above to set another remote control function.

The recording module 110 is further configured for recording voice command input of the user through the microphone 11.

The detecting module 120 is further configured for processing the voice command input, and detecting voice characteristics of the voice command input.

The determining module 150 is further configured for determining whether the voice characteristics of the voice command input match the voice characteristics of one of the plurality of voice command settings stored in the memory 12. For example, if the count of the wave peaks in the voice command input is equal to the count of the wave peaks in one of the plurality of voice command settings, and the voice command input has more than 60 percent frequency bands of the wave peaks the same as frequency bands of the wave peaks in the voice command setting, the voice characteristics of the voice command input are determined to match the voice characteristics of the voice command setting.

The controlling module 160 is configured for sending the remote control signal corresponding to the voice command setting that matches the voice command input to the wireless receiver 21 of the electronic device 2 through the wireless transmitter 13, so as to control the electronic device 2 remotely according the remote control signal.

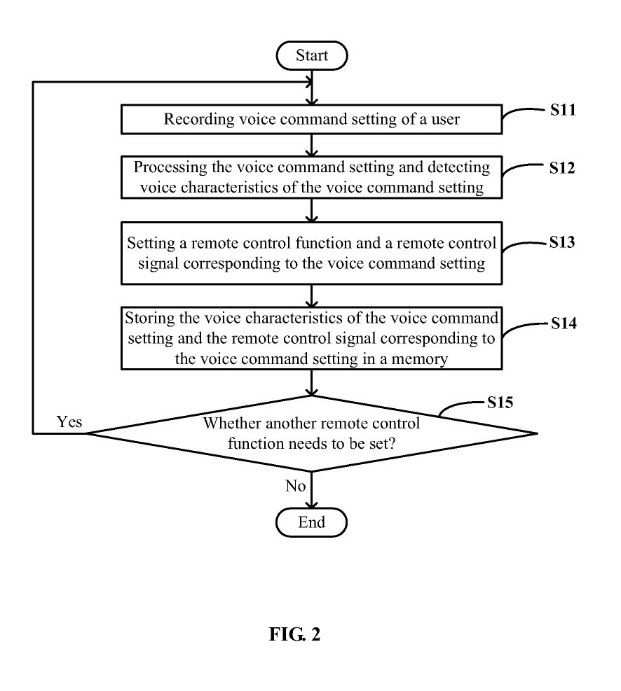

FIG. 2 is a flowchart of preparations for controlling an electronic device with voice commands using a mobile phone in accordance with the exemplary embodiment.

In step S11, the recording module 110 records the voice command setting of the user through the microphone 11.

In step S12, the detecting module 120 processes the voice command setting and detects the voice characteristics of the voice command setting. The voice characteristics of the voice command setting may include, but not limited to the count of wave peaks, frequency bands of the wave peaks.

In step S13, the setting module 130 sets the remote control function and the remote control signal corresponding to the voice command setting. The remote control function may include, but not limited to, the volume adjustment, the color settings, and a channel switching.

In step S14, the storing module 140 stores the voice characteristics of the voice command setting and the remote control signal corresponding to the voice command setting in the memory 12.

In step S15, the determining module 150 determines whether another remote control function needs to be set. If another remote control function needs to be set, the procedure returns to the step S11; otherwise, if no more remote control function needs to be set, the procedure ends.

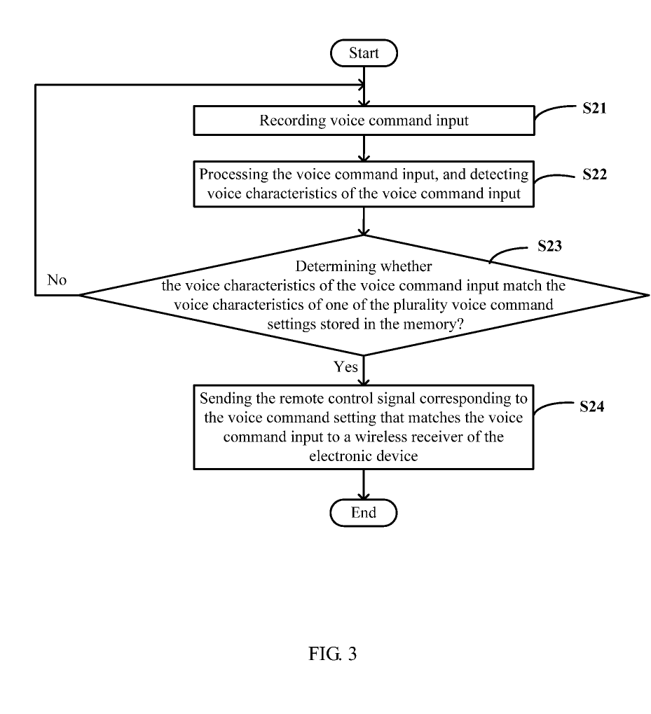

FIG. 3 is a flowchart of a method for controlling an electronic device with voice commands using a mobile phone in accordance with the exemplary embodiment.

In step S21, the recording module 110 records the voice command input through the microphone 11.

In step S22, the detecting module 120 processes the voice command input, and detects the voice characteristics of the voice command input.

In step S23, the determining module 150 determines whether the voice characteristics of the voice command input match the voice characteristics of one of the plurality of voice command settings stored in the memory 12. For example, if the count of the wave peaks in the voice command input is equal to the count of the wave peaks in one of the plurality of voice command settings, and the voice command input has more than 60 percent frequency bands of the wave peaks the same as frequency bands of the wave peaks in the voice command setting, the voice characteristics of the voice command input are determined to match the voice characteristics of the voice command setting.

In step S24, if the voice characteristics of the voice command input are determined to match the voice characteristics of one of the plurality of voice command settings stored in the memory 12, the controlling module 160 sends the remote control signal corresponding to the voice command setting that matches the voice command input to the wireless receiver 21 of the electronic device 2 through the wireless transmitter 13, so as to control the electronic device 2 remotely according the remote control signal.

If the voice characteristics of the voice command input are determined to do not match the voice characteristics of any one of the voice command settings stored in the memory 12 in the step S23, the procedure returns to step S21.

It should be emphasized that the above-described embodiments of the exemplary embodiments are merely possible examples of implementations, merely set forth for a clear understanding of the principles of the invention. Many variations and modifications may be made to the above-described exemplary embodiment without departing substantially from the spirit and principles of the invention. All such modifications and variations are intended to be included herein within the scope of this disclosure and the above-described exemplary embodiment and protected by the following claims.

What is claimed is:

1. A system for controlling an electronic device with voice commands using a mobile phone, the system comprising:
a memory for storing voice characteristics of voice command settings of a user and corresponding remote control signals of the voice command settings;
a recording module configured for recording voice command input of the user through a microphone in the mobile phone;
a detecting module configured for processing the voice command input, and detecting voice characteristics of the voice command input;
a determining module configured for determining whether the voice characteristics of the voice command input match voice characteristics of one of the plurality of voice command settings stored in the memory; and
a controlling module configured for sending the remote control signal corresponding to the voice command setting that matches the voice command input to a wireless receiver of the electronic device through a wireless transmitter of the mobile phone, so as to control the electronic device remotely according the remote control signal.

2. The system according to claim 1, wherein the voice characteristics comprises a count of wave peaks, frequency bands of the wave peaks.

3. The system according to claim 1, further comprising a setting module and a storing module, wherein:
the recording module is further configured for recording voice command setting of the user through the microphone;
the detecting module is further configured for processing the voice command setting and detecting voice characteristics of the voice command setting;
the setting module is configured for setting a remote control function and a remote control signal corresponding to the voice command setting; and
the storing module is configured for storing the voice characteristics of the voice command setting and the remote control signal corresponding to the voice command setting in the memory.

4. The system according to claim 3, wherein the determining module is further configured for determining whether another remote control function needs to be set.

5. A method for controlling an electronic device with voice commands using a mobile phone, the method comprising:
storing voice characteristics of voice command settings of a user and corresponding remote control signals of the voice command settings in a memory;
recording voice command input of the user through a microphone in the mobile phone;
processing the voice command input, and detecting voice characteristics of the voice command input;
determining whether the voice characteristics of the voice command input match voice characteristics of one of the plurality of voice command settings stored in the memory; and
sending the remote control signal corresponding to the voice command setting that matches the voice command input to a wireless receiver of the electronic device through a wireless transmitter of the mobile phone, so as to control the electronic device remotely according the remote control signal.

6. The method according to claim 5, wherein the voice characteristics comprises a count of wave peaks, frequency bands of the wave peaks.

7. The method according to claim 5, further comprising:
recording voice command setting of the user through the microphone;
processing the voice command setting and detecting voice characteristics of the voice command setting;
setting a remote control function and a remote control signal corresponding to the voice command setting; and
storing the voice characteristics of the voice command setting and the remote control signal corresponding to the voice command setting in the memory.
